(19) United States
(12) Patent Application Publication
(10) Pub. No.: US 2025/0182447 A1
(43) Pub. Date: Jun. 5, 2025

(54) DATA ANALYSIS APPARATUS, METHOD, AND NON-TRANSITORY COMPUTER-READABLE STORAGE MEDIUM

(71) Applicant: KABUSHIKI KAISHA TOSHIBA, Tokyo (JP)

(72) Inventors: Kouta NAKATA, Chigasaki Kanagawa (JP); Kentaro TAKAGI, Yokohama Kanagawa (JP); Yaling TAO, Kawasaki Kanagawa (JP)

(73) Assignee: KABUSHIKI KAISHA TOSHIBA, Tokyo (JP)

(21) Appl. No.: 18/815,486

(22) Filed: Aug. 26, 2024

(30) Foreign Application Priority Data
Dec. 1, 2023 (JP) 2023-203828

(51) Int. Cl. G06V 10/762; G06V 10/44; G06V 10/74

(52) U.S. Cl. CPC G06V 10/762; G06V 10/44; G06V 10/761

(57) ABSTRACT

According to one embodiment, a data analysis apparatus includes processing circuitry. The processing circuitry acquires a plurality of pieces of first data satisfying a first condition, generates a plurality of first feature vectors by unsupervised learning of the plurality of pieces of first data, generates a first clustering result by clustering the plurality of first feature vectors, acquires a plurality of pieces of second data satisfying a second condition different from the first condition, generates a plurality of second feature vectors by unsupervised learning of at least some of the plurality of pieces of first data and the plurality of pieces of second data, generates a second clustering result by clustering the second feature vectors, and generates a comparison result regarding the plurality of pieces of first data and the plurality of pieces of second data by comparing the first clustering result with the second clustering result.

### CROSS-REFERENCE TO RELATED APPLICATIONS

This application is based upon and claims the benefit of priority from Japanese Patent Application No. 2023-203828, filed Dec. 1, 2023, the entire contents of which are incorporated herein by reference.

### FIELD

Embodiments described herein relate generally to a data analysis apparatus, a method, and a non-transitory computer-readable storage medium.

### BACKGROUND

In the manufacturing field, efforts to monitor the occurrence of defects and faults and improve productivity by classifying inspection images of products by machine learning have been widened. As a method of classifying an inspection image by machine learning, supervised learning is known in which a teacher label serving as a classification criterion is manually assigned in advance and a classification model is trained by a method such as deep learning. However, in order to train a classification model with high accuracy by supervised learning, it is necessary to accurately assign teacher labels to a large number of images.

As another method of classifying an inspection image by machine learning, an unsupervised learning method of performing classification using a similarity or a distance between images is known. Since the unsupervised learning method does not require manual labeling, it is possible to classify a large amount of unknown images, and it is possible to grasp the outline of the image data set from the classification result. In recent years, an unsupervised learning method using deep learning has been proposed, and performance has been greatly improved by automatically learning features of images and performing classification using their similarity and distance.

As described above, in the manufacturing field, efforts have been made to grasp the occurrence situation of defects and faults and reduce the operation cost of analysis by classifying inspection images using the unsupervised learning method. For example, by classifying inspection images accumulated in a large amount in a factory by an unsupervised learning method, the number of faulty or defective images generated can be confirmed, and what kind of defect and fault and how many defects and faults has occurred can be known. In addition, since manual work is unnecessary in unsupervised learning, the user can classify the inspection images at a necessary timing, and the user can also classify and check the inspection image of the previous day at the start of work.

Specifically, in factories, more detailed analysis is performed by comparing the occurrence situation of defects and faults for each manufacturing condition. For example, by comparing the occurrence of defects before and after maintenance of the device, it is possible to check the effect of maintenance and the presence or absence of adverse effects due to maintenance. In addition, by comparing the occurrence of defects for two inspection apparatuses that perform the same inspection, it is possible to check the inspection accuracy of each inspection apparatus, the habit of photographing accompanying the inspection, and the like. As described above, by grasping the defect specific to the manufacturing condition, the cause of the defect is clear, and measures can be taken early.

In the related art, a technique of performing unsupervised learning using existing data and new data on the assumption of time series data is known. This technique reduces a work cost for assigning teacher labels by collectively assigning teacher labels to existing data using a classification result of unsupervised learning of the existing data in labeling assistance for supervised learning of time series data. In addition, in this technology, by mixing existing data and new data and performing unsupervised learning, it is possible to assign teacher labels to the new data using the teacher labels of the existing data classified into the same group. In addition, this technology can also assign a teacher label to time series data of a newly generated trend by checking a group including only new data. In these cases, the analysis cost of the time series data can be reduced by considering the existing data and the new data as data under different manufacturing conditions.

On the other hand, in the above technology, time series data acquired from a sensor or the like is a target, and a difference in features between existing data and new data is not considered. In a factory, completely different defects and faults may occur due to differences in manufacturing conditions, and in order to classify inspection images obtained by photographing the defects and faults with high accuracy, it is necessary to learn features suitable for each of the defects and faults. In a case where a new inspection image is classified using a feature suitable for an existing image, a defect and a fault occurring only in the new inspection image cannot be classified and may be overlooked.

In addition, the above-described technology is intended to perform supervised learning by assigning a teacher label to new data, and is not a method suitable for analysis of comparing existing data with new data.

In a factory, a large number of apparatuses having different properties are operated, and the state of the apparatus is constantly changed, such as maintenance, manufacturing process change, and startup of a new product. Therefore, there is a demand for a method of supporting analysis by learning features of defects and faults in response to differences in manufacturing conditions such as differences in apparatuses and states and comparing the features with high accuracy.

### BRIEF DESCRIPTION OF DRAWINGS

FIG. 1 is a block diagram illustrating a configuration of a data analysis system including a data analysis apparatus according to the embodiment.

FIG. 2 is a block diagram illustrating a configuration of a data analysis apparatus according to the embodiment.

FIG. 3 is a block diagram illustrating a specific configuration of a first training unit in FIG. 2.

FIG. 4 is a flowchart illustrating an operation of the data analysis apparatus according to the embodiment.

FIG. 5 is a diagram illustrating a plurality of pieces of first data according to the embodiment.

FIG. 6 is a flowchart illustrating a first feature vector generation process in FIG. 4.

FIG. 7 is a diagram for describing the first feature vector generation process according to the embodiment.

FIG. 8 is a table in which the first data and the first feature vector are associated with each other according to the embodiment.

FIG. 9 is a table in which the first data and the first cluster number are associated with each other according to the embodiment.

FIG. 10 is a table in which the first data, the first cluster number, and the first cluster label are associated with each other according to the embodiment.

FIG. 11 is a diagram illustrating a plurality of pieces of second data according to the embodiment.

FIG. 12 is a diagram for describing a second feature vector generation process according to the embodiment.

FIG. 13 is a table in which the first and second data and the second feature vector are associated with each other according to the embodiment.

FIG. 14 is a table in which the first and second data and the second cluster number are associated with each other according to the embodiment.

FIG. 15 is a diagram illustrating a comparison result regarding a cluster CL1 according to the embodiment.

FIG. 16 is a diagram illustrating a comparison result regarding a cluster CL2 according to the embodiment.

FIG. 17 is a diagram illustrating a comparison result regarding a cluster CL3 according to the embodiment.

FIG. 18 is a diagram illustrating a comparison result reflecting features including data of different conditions in another specific example of the embodiment.

FIG. 19 is a block diagram illustrating a hardware configuration of a computer according to an embodiment.

### DETAILED DESCRIPTION

In general, according to one embodiment, a data analysis apparatus includes processing circuitry. The processing circuitry acquires a plurality of pieces of first data satisfying a first condition, generates a plurality of first feature vectors by unsupervised learning of the plurality of pieces of first data, generates a first clustering result by clustering the plurality of first feature vectors, acquires a plurality of pieces of second data satisfying a second condition different from the first condition, generates a plurality of second feature vectors by unsupervised learning of at least some of the plurality of pieces of first data and the plurality of pieces of second data, generates a second clustering result by clustering the second feature vectors, and generates a comparison result regarding the plurality of pieces of first data and the plurality of pieces of second data by comparing the first clustering result with the second clustering result.

Hereinafter, embodiments of a data analysis apparatus will be described in detail with reference to the drawings.

### Embodiments

FIG. 1 is a block diagram illustrating a configuration of a data analysis system including a data analysis apparatus according to the embodiment. A data analysis system 1 of FIG. 1 includes a data analysis apparatus 100, one or more data storage units, and an output apparatus 120. In FIG. 1, a first data storage unit 111 and a second data storage unit 112 are illustrated as one or more data storage units. These two data storage units store data satisfying different conditions. This condition is, for example, different apparatuses themselves in the case of a plurality of apparatuses that performs the same inspection, and is the date and time, before and after maintenance, and before and after a change in manufacturing conditions (manufacturing process) in the case of using one apparatus. In other words, the type of condition is any of different apparatuses, the date and time, before and after maintenance, and before and after a change in manufacturing process. The data analysis apparatus 100 analyzes a difference between different conditions based on a plurality of data satisfying different conditions. The output apparatus 120 displays display data based on the analysis result.

In the present embodiment, as a specific example of data, an inspection image (hereinafter, it may be simply referred to as an image) captured in an inspection in a manufacturing process will be described. This inspection image is, for example, an image having a defect detected in the appearance inspection of the semiconductor product. As a specific example of the condition, before and after maintenance is assumed.

The first data storage unit 111 stores a plurality of pieces of first data satisfying the first condition. The first condition is, for example, before maintenance. Specifically, the first data storage unit 111 stores a plurality of images before maintenance.

The second data storage unit 112 stores a plurality of pieces of second data satisfying a second condition different from the first condition. The second condition is, for example, after maintenance. Specifically, the second data storage unit 112 stores a plurality of images after maintenance.

The output apparatus 120 is, for example, a monitor. The output apparatus 120 receives display data from the data analysis apparatus 100. The output apparatus 120 displays the display data. Note that the output apparatus 120 is not limited to a monitor as long as display data can be displayed. For example, the output apparatus 120 may be a projector and a printer. Furthermore, the output apparatus 120 may include a speaker.

Note that the data analysis apparatus 100 may include at least one of the first data storage unit 111, the second data storage unit 112, and the output apparatus 120. In addition, the first data storage unit 111 and the second data storage unit 112 may be configured by separate storage apparatuses, or may be configured by one storage apparatus.

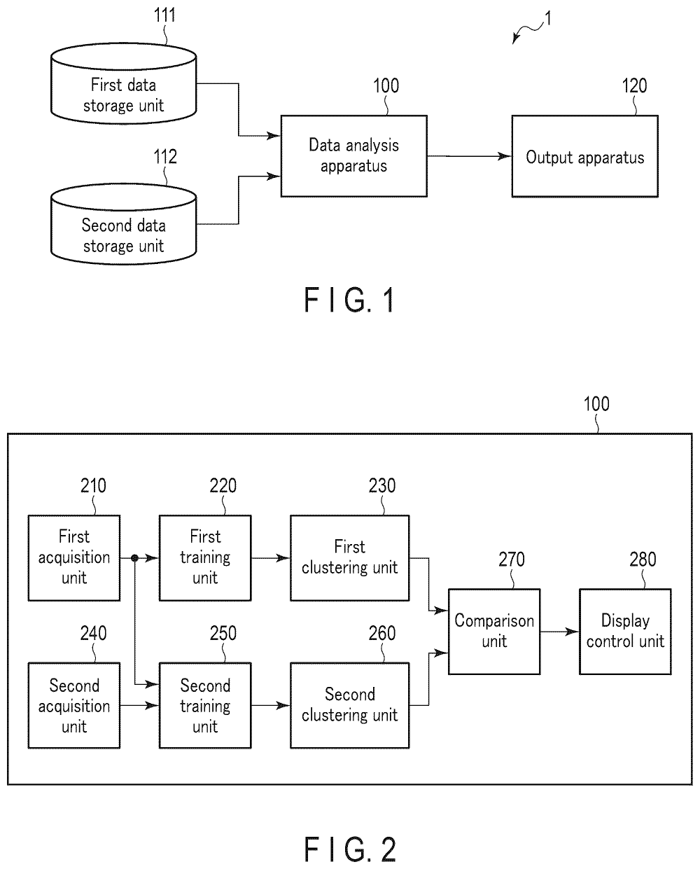

FIG. 2 is a block diagram illustrating a configuration of the data analysis apparatus according to the embodiment. The data analysis apparatus 100 in FIG. 2 includes a first acquisition unit 210, a first training unit 220, a first clustering unit 230, a second acquisition unit 240, a second training unit 250, a second clustering unit 260, a comparison unit 270, and a display control unit 280.

The first acquisition unit 210 acquires a plurality of pieces of first data satisfying the first condition. For example, the first acquisition unit 210 acquires a plurality of pieces of first data from the first data storage unit 111. The first acquisition unit 210 outputs the plurality of pieces of first data to the first training unit 220, and outputs at least some of the plurality of pieces of first data to the second training unit 250.

The number of at least some of the plurality of pieces of first data output from the first acquisition unit 210 to the second training unit 250 may be based on a result (clustering result) of clustering by the first clustering unit 230 described later. For example, the number of some pieces of data desirably maintains the ratio of the first data included in each of the plurality of clusters generated by the clustering result. In this way, the user can easily compare the data with the plurality of pieces of second data satisfying the second condition, and can easily find a new feature.

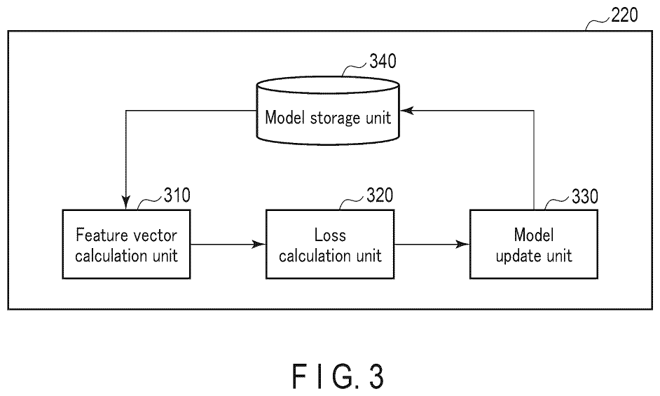

The first training unit 220 receives a plurality of pieces of first data from the first acquisition unit 210. The first training unit 220 iteratively trains the learning model by unsupervised learning of the plurality of pieces of first data. In addition, the first training unit 220 outputs a plurality of first feature vectors by inputting a plurality of pieces of first data to the learning model. In other words, the first training unit 220 generates a plurality of first feature vectors by unsupervised learning of the plurality of pieces of first data. The first training unit 220 outputs the plurality of first feature vectors to the first clustering unit 230. Hereinafter, a specific configuration of the first training unit 220 will be described with reference to FIG. 3.

FIG. 3 is a block diagram illustrating a specific configuration of the first training unit in FIG. 2. The first training unit 220 in FIG. 3 includes a feature vector calculation unit 310, a loss calculation unit 320, a model update unit 330, and a model storage unit 340. Each unit will be described below with respect to one piece of first data of the plurality of pieces of first data.

The feature vector calculation unit 310 calculates a first feature vector based on the first data. Specifically, the feature vector calculation unit 310 outputs (calculates) the first feature vector by inputting the first data to the learning model stored in the model storage unit 340. The feature vector calculation unit 310 outputs the first feature vector to the loss calculation unit 320.

In the present embodiment, a deep neural network (DNN) model that outputs a feature vector by inputting an image is used as a learning model used for calculation of the feature vector. Regarding this DNN, the model structure and the structure parameters are set in advance by learning conditions.

Furthermore, the feature vector calculation unit 310 may output a feature vector output from the output layer of the DNN as the first feature vector, or may output a feature vector output from an intermediate layer before the output layer as the first feature vector.

The loss calculation unit 320 receives the first feature vector from the feature vector calculation unit 310. The loss calculation unit 320 calculates the first loss using the first feature vector. The loss calculation unit 320 outputs the first loss to the model update unit 330.

In order to output a feature vector suitable for clustering, the loss calculation unit 320 calculates the first loss using, for example, the method (IDFD) described in reference literature (Yaling Tao, Kentaro Takagi, Kouta Nakata, “Clustering-friendly Representation Learning via Instance Discrimination And Feature Decorrelation”, arXiv: 2106.00131, ICLR2021.). The IDED is a combination of a technique called instance discrimination (ID) and a technique called feature decorrelation (FD) as a loss function.

Specifically, the ID is, for example, a method in which a loss decreases as an error of a feature vector obtained from different images increases, and includes a first temperature parameter that controls sensitivity of the error. The FD is, for example, a method in which the lower the correlation between elements of different feature vectors, the smaller the loss, and includes a second temperature parameter for controlling the sensitivity of the correlation. The IDFD obtained by combining these methods has a balancing parameter that adjusts the degree of influence of each loss in a case of calculating a combined loss (combined loss) based on the loss due to the ID and the loss due to the FD.

Briefly, the loss calculation unit 320 can train a learning model for extracting a feature amount in which a distance between similar images is short and a distance between dissimilar images is long for images using the IDFD.

The model update unit 330 receives the first loss from the loss calculation unit 320. The model update unit 330 updates the learning model using the first loss. Specifically, the model update unit 330 applies the optimization parameter based on the first loss to the learning model to update the internal parameter of the learning model. The model update unit 330 outputs the updated parameter of the learning model to the model storage unit 340.

The model storage unit 340 receives the parameter of the learning model from the model update unit 330. The model storage unit 340 updates and stores the learning model based on the parameter.

As described above, the first training unit 220 can perform unsupervised learning using a model that extracts a feature amount in which a distance between similar images is short and a distance between dissimilar images is long.

The first clustering unit 230 receives a plurality of first feature vectors from the first training unit 220. The first clustering unit 230 generates a first clustering result by clustering a plurality of first feature vectors. The first clustering unit 230 outputs the first clustering result to the comparison unit 270.

As a clustering method, for example, K-Means clustering is used. The first clustering result includes a first cluster number that is an ID of a first cluster to which the first data corresponding to the first feature vector belongs. That is, by performing clustering in the first clustering unit 230, a first cluster number is assigned to each of the plurality of pieces of first data. Therefore, the first clustering result includes, for example, data in which the first feature vector and the first cluster number for distinguishing each cluster are associated with each other.

In addition, the first clustering unit 230 may assign a first cluster label corresponding to the first cluster number. The assignment of the first cluster label includes manual assignment and assignment using machine learning. In manual assignment, a user checks data (image) included in a cluster, and assigns, for example, a first cluster label indicating a feature of the image to each cluster. In the assignment using machine learning, an image included in a cluster is analyzed, and a first cluster label indicating a feature of the image is automatically assigned. For manual assignment of the first cluster label, the number of clusters (the number of clusters) is extremely small relative to the number of images input to the data analysis apparatus, so that the burden on the user is small.

The second acquisition unit 240 acquires a plurality of pieces of second data satisfying a second condition different from the first condition. For example, the second acquisition unit 240 acquires a plurality of pieces of second data from the second data storage unit 112. The second acquisition unit 240 outputs the plurality of pieces of second data to the second training unit 250.

The second training unit 250 receives at least some of the plurality of pieces of first data from the first acquisition unit 210 and receives the plurality of pieces of second data from the second acquisition unit 240. The second training unit 250 generates a plurality of second feature vectors by unsupervised learning of at least some of the plurality of pieces of first data and the plurality of pieces of second data. The second training unit 250 outputs the plurality of second feature vectors to the second clustering unit 260. Note that the specific configuration and processing of the second training unit 250 are similar to those of the first training unit 220, and thus the description thereof will be omitted.

The second clustering unit 260 receives a plurality of second feature vectors from the second training unit 250. The second clustering unit 260 generates a second clustering result by clustering a plurality of second feature vectors. The second clustering unit 260 outputs the second clustering result to the comparison unit 270.

As a clustering method, for example, K-Means clustering is used. The second clustering result includes a second cluster number which is an ID of a second cluster to which the first and second data corresponding to the second feature vector belong. That is, by performing clustering in the second clustering unit 260, the second cluster number is assigned to each of the plurality of pieces of first and second data. Therefore, the second clustering result includes, for example, data in which the second feature vector and the second cluster number for distinguishing each cluster are associated with each other.

In addition, the second clustering unit 260 may perform clustering such that the number of clusters included in the second clustering result is larger than the number of clusters included in the first clustering result by the first clustering unit 230. For example, in a case where a feature clearly different from the first data is observed in the second data, it is expected that the number of clusters increases, and thus, it is conceivable that comparison is easy.

The comparison unit 270 receives the first clustering result from the first clustering unit 230 and receives the second clustering result from the second clustering unit 260. The comparison unit 270 compares the first clustering result with the second clustering result to generate a comparison result regarding the plurality of pieces of first data and the plurality of pieces of second data. The comparison result is, for example, a graph indicating the number or ratio of the first data and the second data that are included in the cluster in the second clustering result. The comparison unit 270 outputs the comparison result to the display control unit 280.

The display control unit 280 receives the comparison result from the comparison unit 270. The display control unit 280 generates display data based on the comparison result and displays the display data on the display which is the output apparatus 120.

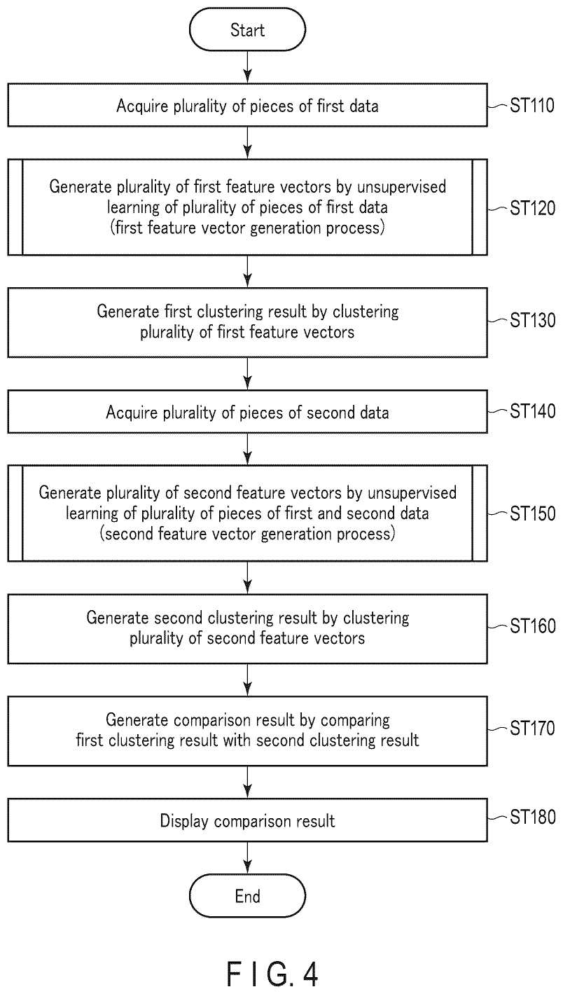

The configurations of the data analysis system 1 and the data analysis apparatus 100 according to the embodiment have been described above. Next, the operation of the data analysis apparatus 100 will be described with reference to the flowchart of FIG. 4.

FIG. 4 is a flowchart illustrating an operation of the data analysis apparatus according to the embodiment. The processing of the flowchart of FIG. 4 starts when the user executes the data analysis program.

### Step ST110

In a case where the data analysis program is executed by the data analysis apparatus 100, the first acquisition unit 210 acquires a plurality of pieces of first data from the first data storage unit 111.

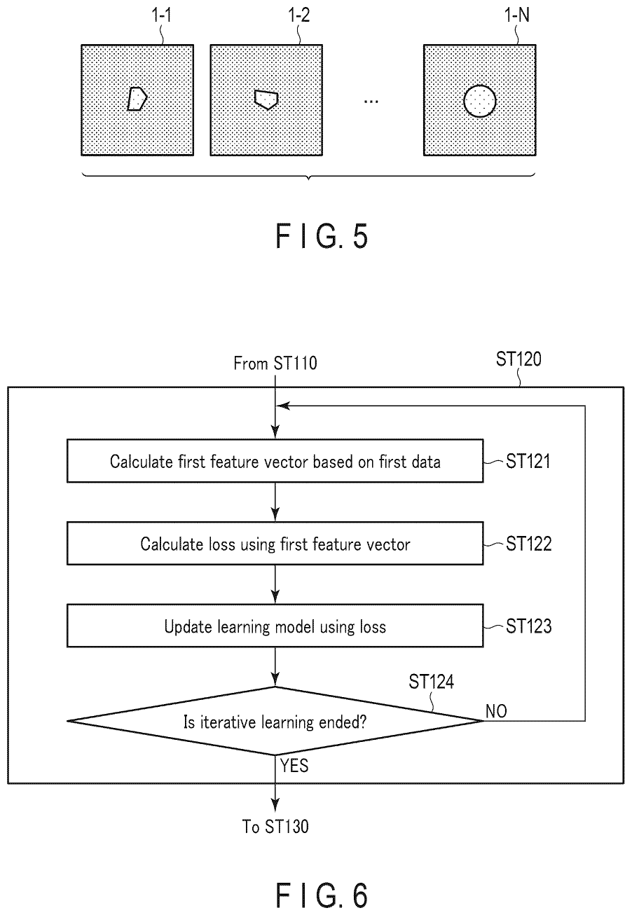

Hereinafter, a plurality of pieces of first data will be described with reference to FIG. 5.

FIG. 5 is a diagram illustrating a plurality of pieces of first data according to the embodiment. FIG. 5 illustrates an image 1-1, an image 1-2, . . . , and an image 1-N as the plurality of pieces of first data. N is the total number of pieces of first data. Each of the images 1-1 and 1-2 includes a polygonal defect (hereinafter, referred to as an angular defect), and the image 1-N includes a circular defect (hereinafter, referred to as a round defect).

### Step ST120

After the first acquisition unit 210 acquires the plurality of pieces of first data, the first training unit 220 generates the plurality of first feature vectors by unsupervised learning of the plurality of pieces of first data. Hereinafter, the processing of step ST120 is referred to as a “first feature vector generation process”. A specific example of the first feature vector generation process will be described with reference to a flowchart of FIG. 6.

FIG. 6 is a flowchart illustrating the first feature vector generation process in FIG. 4. The flowchart of FIG. 6 transitions from step ST110 of FIG. 4.

### Step ST121

After the first acquisition unit 210 acquires the plurality of pieces of first data, the feature vector calculation unit 310 calculates the first feature vector based on the first data.

### Step ST122

After the feature vector calculation unit 310 calculates the first feature vector, the loss calculation unit 320 calculates the first loss using the first feature vector.

### Step ST123

After the loss calculation unit 320 calculates the first loss, the model update unit 330 updates the learning model using the first loss.

Note that, to be precise, the “iterative learning” is performed by repeating the processing from step ST121 to step ST123 for all of the plurality of pieces of first data. That processing for all of the plurality of pieces of first data goes around is expressed as “one epoch”.

### Step ST124

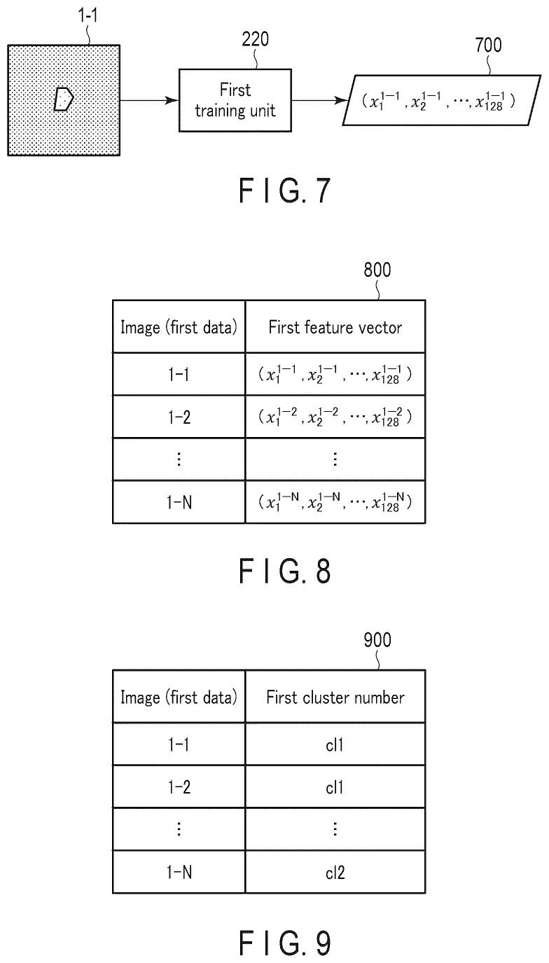

After the processing for all of the plurality of pieces of first data goes round, the first training unit 220 determines whether to end the iterative learning. In this determination, for example, a predetermined number of epochs may be used as the end condition. In a case where it is determined not to end the iterative learning, the process returns to step ST121. In a case where it is determined to end the iterative learning, the first training unit 220 outputs (generates) the plurality of first vectors, and the process proceeds to step ST130. Hereinafter, the first feature vector generation process will be described with reference to FIG. 7, and a table in which the first data and the first feature vector are associated with each other will be described with reference to FIG. 8.

FIG. 7 is a diagram for describing the first feature vector generation process according to the embodiment. The first training unit 220 outputs a first feature vector 700 by inputting the image 1-1 to the learning model. The first feature vector 700 is, for example, vector data having a 128 dimensional feature amount output from the output layer of the DNN in the learning model. Specifically, the first feature vector 700 is expressed as (x₁¹⁻¹, x₂¹⁻¹, . . . , x₁₂₈¹⁻¹). At this time, the subscript of respective elements x represents the number of the element, and the superscript of respective elements x represents the number of the image.

FIG. 8 is a table in which the first data and the first feature vector are associated with each other according to the embodiment. In the table 800 of FIG. 8, a first feature vector is associated with each of the images 1-1 to 1-N as a plurality of pieces of first data as a processing result of the first vector generation process.

In the table 800, for example, the image “1-1” and the first feature vector “(x₁¹⁻¹, x₂¹⁻¹, . . . , x₁₂₈¹⁻¹)” are associated with each other, the image “1-2” and the first feature vector “(x₁¹⁻², x₂¹⁻², . . . , x₁₂₈¹⁻²)” are associated with each other, and the image “1-N” and the first feature vector “(x₁^{1-N}, x₂^{1-N}, . . . , x₁₂₈^{1-N})” are associated with each other. For convenience of description, the plurality of images and the plurality of first feature vectors is represented in a table, but at least the image (first data) and the first feature vector may be associated with each other. The same applies to the following.

### Step ST130

After the first training unit 220 generates a plurality of first feature vectors, the first clustering unit 230 generates a first clustering result by clustering the plurality of first feature vectors. The first clustering result includes a first cluster number. In addition, the first clustering result may include a first cluster label corresponding to the first cluster number. Hereinafter, the first clustering result will be described with reference to FIG. 9.

FIG. 9 is a table in which the first data and the first cluster number are associated with each other according to the embodiment. In a table 900 of FIG. 9, the first cluster number is associated with each of images 1-1 to 1-N as a plurality of pieces of first data.

Specifically, in the table 900, for example, the image “1-1” and the first cluster number “cl1” are associated with each other, the image “1-2” and the first cluster number “cl1” are associated with each other, and the image “1-N” and the first cluster number “cl2” are associated with each other.

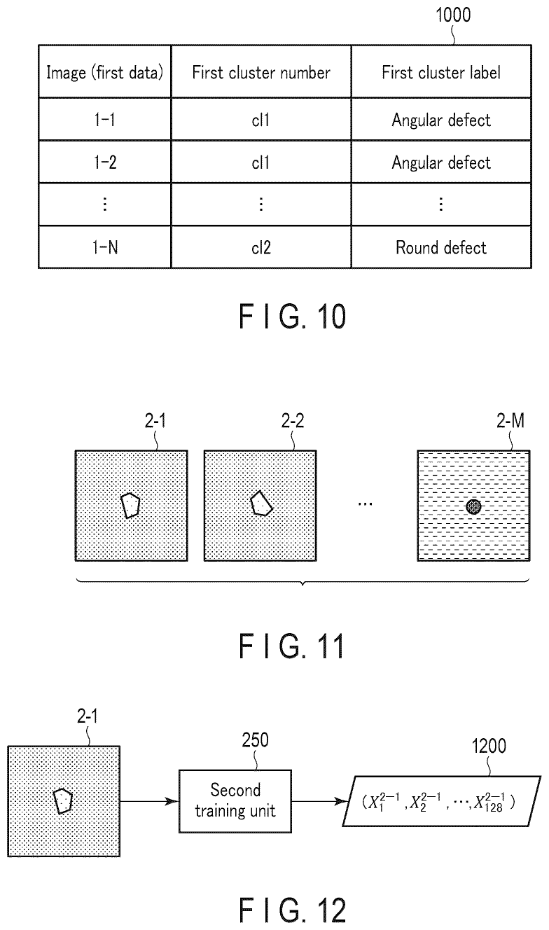

In step ST130, the user may assign a first cluster label corresponding to the first cluster number. Hereinafter, an example in which a first cluster label corresponding to a first cluster number is assigned will be described with reference to FIG. 10.

FIG. 10 is a table in which the first data, the first cluster number, and the first cluster label are associated with each other according to the embodiment. A table 1000 of FIG. 10 is obtained by further adding an item of the first cluster label to the table 900 of FIG. 9. In the table 1000, for example, the image “1-1”, the first cluster number “cl1”, and the first cluster label “angular defect” are associated with each other, the image “1-2”, the first cluster number “cl1”, and the first cluster label “angular defect” are associated with each other, and the image “1-N”, the first cluster number “cl2”, and the first cluster label “round defect” are associated with each other. Hereinafter, it is assumed that the first cluster label is assigned to the first data.

### Step ST140

After the first clustering unit 230 generates the first clustering result, the second acquisition unit 240 acquires at least some of the plurality of pieces of first data from the first data storage unit 111, and acquires the plurality of pieces of second data from the second data storage unit 112. Hereinafter, the plurality of pieces of second data will be described with reference to FIG. 11.

FIG. 11 is a diagram illustrating a plurality of pieces of second data according to the embodiment. FIG. 11 illustrates an image 2-1, an image 2-2, . . . , and an image 2-M as the plurality of pieces of second data. M is the total number of the second data. Each of the images 2-1 and 2-2 includes an angular defect, and the image 1-M includes a new defect that is neither an angular defect nor a round defect.

Hereinafter, in step ST140, it is assumed that the second acquisition unit 240 has acquired all the data of the plurality of pieces of first data from the first data storage unit 111. In addition, the total number N of the plurality of pieces of first data and the total number M of the plurality of pieces of second data are assumed to be the same.

### Step ST150

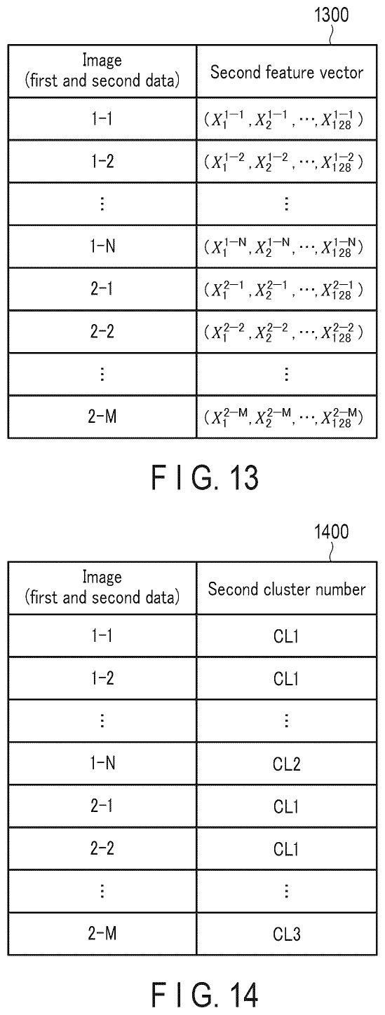

After the second acquisition unit 240 acquires the plurality of pieces of first and second data, the second training unit 250 generates the plurality of second feature vectors by unsupervised learning of the plurality of pieces of first and second data. Hereinafter, the processing of step ST150 is referred to as a “second feature vector generation process”. Since the specific example of the second feature vector generation process is similar to the specific example of the first feature vector generation process, the description thereof will be omitted. Hereinafter, the first feature vector generation process will be described with reference to FIG. 12, and a table in which the second data and the second feature vector are associated with each other will be described with reference to FIG. 13.

FIG. 12 is a diagram for describing the second feature vector generation process according to the embodiment. The second training unit 250 outputs a second feature vector 1200 by inputting the image 2-1 to the learning model. The second feature vector 1200 is, for example, vector data having a 128 dimensional feature amount output from the output layer of the DNN in the learning model. Specifically, the second feature vector 1200 is expressed as (X₁²⁻¹, X₂²⁻¹,., . . . , X₁₂₈²⁻¹). At this time, the subscript of respective elements X represents the number of the element, and the superscript of respective elements X represents the number of the image.

FIG. 13 is a table in which the first and second data and the second feature vector are associated with each other according to the embodiment. In the table 1300 of FIG. 13, as a processing result of the second vector generation process, the second feature vector is associated with each of the images 1-1 to 1-N and the images 2-1 to 2-M as the plurality of pieces of first and second data.

In the table 1300, for example, the image “1-1” and the second feature vector “(X₁¹⁻¹, X₂¹⁻¹, . . . , X₁₂₈¹⁻¹)” are associated with each other, the image “1-2” and the second feature vector “(X₁¹⁻², X₂¹⁻², . . . , X₁₂₈¹⁻²)” are associated with each other, the image “1-N” and the second feature vector “(X₁^{1-N}, X₂^{1-N}, . . . , X₁₂₈^{1-N})” are associated with each other, the image “2-1” and the second feature vector “(X₁²⁻¹, X₂²⁻¹, . . . , X₁₂₈²⁻¹)” are associated with each other, the image “2-2” and the second feature vector “(X₁²⁻², X₂²⁻², . . . , X₁₂₈²⁻²)” are associated with each other, and the image “2-M” and the second feature vector “(X₁^{2-M}, X₂^{2-M}, . . . , X₁₂₈^{2-M})” are associated with each other.

### Step ST160

After the second training unit 250 generates a plurality of second feature vectors, the second clustering unit 260 generates a second clustering result by clustering the plurality of second feature vectors. The second clustering result includes a second cluster number. Hereinafter, the second clustering result will be described with reference to FIG. 14.

FIG. 14 is a table in which the first and second data and the second cluster number are associated with each other according to the embodiment. In the table 1400 of FIG. 14, the second cluster number is associated with each of the image 1-1 to the image 1-N and the image 2-1 to the image 2-M as the plurality of pieces of first and second data.

Specifically, in the table 1400, for example, the image “1-1” and the second cluster number “CL1” are associated with each other, the image “1-2” and the second cluster number “CL1” are associated with each other, the image “1-N” and the second cluster number “CL2” are associated with each other, the image “2-1” and the second cluster number “CL1” are associated with each other, the image “2-2” and the second cluster number “CL1” are associated, and the image “2-M” and the second cluster number “CL3” are associated with each other.

### Step ST170

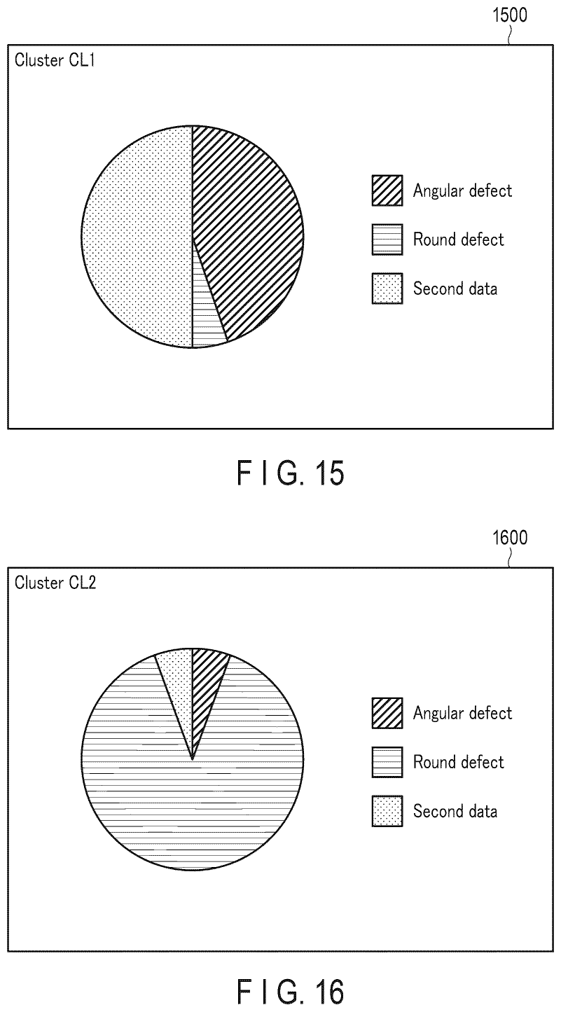

After the second clustering unit 260 generates the second clustering result, the comparison unit 270 compares the first clustering result with the second clustering result to generate a comparison result. Specifically, the comparison unit 270 generates, as a comparison result, a graph indicating a ratio between the first data and the second data that are included in the cluster in the second clustering result. Hereinafter, an example of a comparison result will be described with reference to FIGS. 15 to 17.

FIG. 15 is a diagram illustrating a comparison result regarding a cluster CL1 according to the embodiment. A comparison result 1500 of FIG. 15 is obtained by visualizing the ratio between the first data and the second data belonging to the second cluster number CL1 with a circular graph. The comparison result 1500 circular graph includes, for example, three pieces of data of first data labeled with an angular defect, first data labeled with a round defect, and second data. The ratio between these three pieces of data is, for example, 45:5:50.

According to the circular graph of the comparison result 1500, it can be seen that the ratio between the first data and the second data are about the same. In addition, focusing only on the first data, it can be seen that the ratio of the first data to which the label of the angular defect is assigned is large. From these, it is assumed that the second data is classified as in the first data, that is, the feature of the angular defect are largely included. Therefore, the second cluster number CL1 is assumed to represent the feature of the angular defect.

FIG. 16 is a diagram illustrating a comparison result regarding a cluster CL2 according to the embodiment. A comparison result 1600 of FIG. 16 is obtained by visualizing the ratio between the first data and the second data belonging to the second cluster number CL2 with a circular graph. The circular graph of the comparison result 1600 includes, for example, three pieces of data of first data having an angular defect, first data having a round defect, and second data. The ratio between these three pieces of data is, for example, 5:90:5.

According to the circular graph of the comparison result 1600, it can be seen that the ratio of the second data is extremely smaller than that of the first data. In addition, focusing only on the first data, it can be seen that the ratio of the first data to which the round defect label is assigned is large. From these, it is assumed that the second cluster number CL2 represents the feature of the round defect, and the occurrence of the round defect is greatly reduced in the second data.

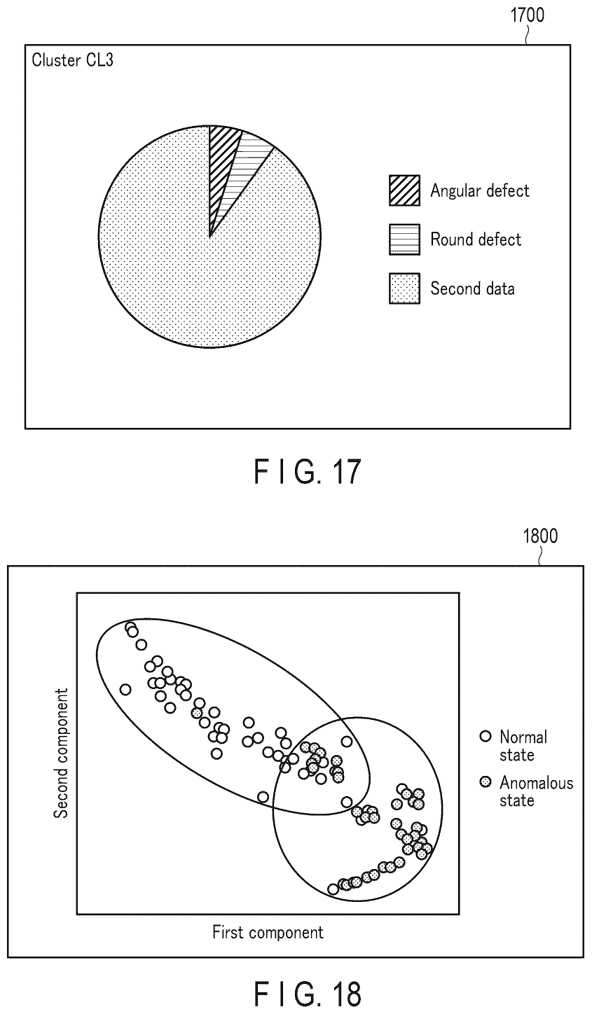

FIG. 17 is a diagram illustrating a comparison result regarding a cluster CL3 according to the embodiment. A comparison result 1700 of FIG. 17 is obtained by visualizing the ratio between the first data and the second data belonging to the second cluster number CL3 with a circular graph. The circular graph of the comparison result 1700 includes, for example, three pieces of data of first data having an angular defect, first data having a round defect, and second data. The ratio between these three pieces of data is, for example, 5:5:90.

According to the circular graph of the comparison result 1700, it can be seen that the ratio of the second data is extremely larger than that of the first data. From this, the second cluster number CL3 is assumed to represent a new feature (new defect) that is neither an angular defect nor a round defect, and a new defect is assumed to have occurred in the second data.

### Step ST180

After the comparison unit 270 generates the comparison result, the display control unit 280 displays the comparison result. Specifically, the display control unit 280 generates display data based on the comparison result and displays the display data on the display that is the output apparatus 120. After step ST180, the processing of the flowchart of FIG. 4 ends.

As described above, the data analysis apparatus according to the embodiment acquires a plurality of pieces of first data satisfying a first condition, generates a plurality of first feature vectors by unsupervised learning of the plurality of pieces of first data, generates a first clustering result by clustering the plurality of first feature vectors, acquires a plurality of pieces of second data satisfying a second condition different from the first condition, generates a plurality of second feature vectors by unsupervised learning of at least some of the plurality of pieces of first data and the plurality of pieces of second data, generates a second clustering result by clustering the second feature vectors, and generates a comparison result regarding the plurality of pieces of first data and the plurality of pieces of second data by comparing the first clustering result with the second clustering result.

Therefore, since the data analysis apparatus according to the embodiment can extract data (for example, an image) having unique features under different conditions, it is possible to accurately compare features of a plurality of pieces of data acquired under different conditions.

### Another Specific Example of Embodiment

In the above embodiment, the use of the inspection image is described as a specific example, but the present invention is not limited thereto. In another specific example, for example, use of an image (monitoring image) of a monitoring camera will be described. The first condition is, for example, before a predetermined time, and the second condition is, for example, after the predetermined time.

Specifically, the first data storage unit 111 stores the first data satisfying the time length before the predetermined time. More specifically, the first data storage unit 111 stores a plurality of pieces of first data (a plurality of first monitoring images) captured during a period from 5 minutes before to 10 minutes before. Similarly, the second data storage unit 112 stores the second data satisfying the time length before the current time and after the predetermined time. More specifically, the second data storage unit 112 stores a plurality of pieces of second data (a plurality of second monitoring images) captured during a period from the current time to 5 minutes before.

Since the processing by the data analysis apparatus 100 is similar to that in the above embodiment, the description thereof will be omitted. In the another specific example, in a case where a state in which there is no change in the monitoring image is ordinary (normal), the learning using the plurality of first monitoring images and the clustering using the plurality of first feature vectors corresponding to the plurality of first monitoring images have substantially constant output results. Here, in a case where there is a change in the monitoring image, that is, in a case where an anomaly occurs in the monitoring image, the first monitoring image and the second monitoring image have different features, and thus, the learning and the clustering have different output results from the normal case. Such comparison of output results will be described with reference to FIG. 18.

FIG. 18 is a diagram illustrating a comparison result reflecting features including data of different conditions in another specific example of the embodiment. A comparison result 1800 of FIG. 18 includes a scatter diagram in which the data obtained in the normal state and the data obtained in the anomalous state are represented by different first component and second component. That is, the comparison result in the another specific example is a correlation diagram in which a plurality of first feature vectors and a plurality of second feature vectors are represented by a plurality of different components. The scatter diagram of the comparison result 1800 indicates that different clusters are formed for the normal state and the anomalous state. Note that, for example, in a case where the different cluster is formed, the data analysis apparatus 100 may notify the user that the different cluster is formed.

As described above, the present data analysis apparatus can be applied not only to the inspection image but also to the monitoring image.

### Hardware Configuration

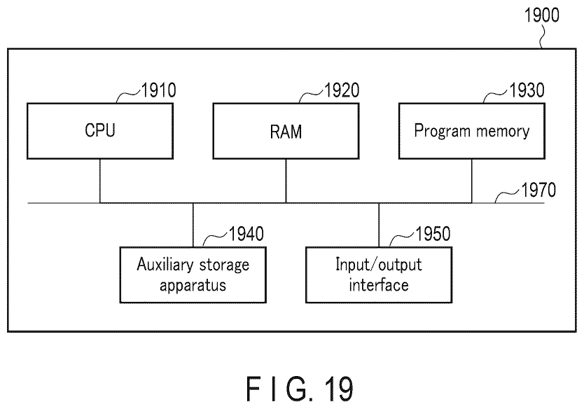

FIG. 19 is a block diagram illustrating a hardware configuration of a computer according to an embodiment. The computer 1900 includes, as hardware, a central processing unit (CPU) 1910, a random access memory (RAM) 1920, a program memory 1930, an auxiliary storage apparatus 1940, and an input/output interface 1950. The CPU 1910 communicates with the RAM 1920, the program memory 1930, the auxiliary storage apparatus 1940, and the input/output interface 1950 via a bus 1960.

The CPU 1910 is an example of a general-purpose processor. The RAM 1920 is used as a working memory for the CPU 1910. The RAM 1920 includes a volatile memory such as a synchronous dynamic random access memory (SDRAM). The program memory 1930 stores various programs including a data analysis program. As the program memory 1930, for example, a read-only memory (ROM), part of the auxiliary storage apparatus 1940, or a combination thereof is used. The auxiliary storage apparatus 1940 non-temporarily stores data. The auxiliary storage apparatus 1940 includes a nonvolatile memory such as an HDD or an SSD.

The input/output interface 1950 is an interface that is connected to or communicates with another device. The input/output interface 1950 is used, for example, for connection or communication with the first data storage unit 111, the second data storage unit 112, and the output apparatus 120 illustrated in FIG. 1.

Each program stored in the program memory 1930 includes a computer-executable instruction. When executed by the CPU 1910, the program (computer-executable instruction) causes the CPU 1910 to execute a predetermined process. For example, when the data analysis program is executed by the CPU 1910, the data analysis program causes the CPU 1910 to execute a series of processes described with respect to each unit of FIGS. 2 and 3.

The program may be provided to the computer 1900 in a state of being stored in a computer-readable storage medium. In this case, for example, the computer 1900 further includes a drive (not illustrated) that reads data from the storage medium, and acquires the program from the storage medium. Examples of the storage medium include a magnetic disk, an optical disk (CD-ROM, CD-R, DVD-ROM, DVD-R, and the like), a magneto-optical disk (MO or the like), and a semiconductor memory. In addition, the program may be stored in a server on the communication network, and the computer 1900 may download the program from the server using the input/output interface 1950.

The processing described in the embodiment is not limited to being performed by a general-purpose hardware processor such as the CPU 1910 executing a program, and may be performed by a dedicated hardware processor such as an application specific integrated circuit (ASIC). The term processing circuit (processing unit) includes at least one general purpose hardware processor, at least one dedicated hardware processor, or a combination of at least one general purpose hardware processor and at least one dedicated hardware processor. In the example illustrated in FIG. 19, the CPU 1910, the RAM 1920, and the program memory 1930 correspond to a processing circuit.

Therefore, according to each of the above embodiments, it is possible to accurately compare features of a plurality of pieces of data acquired under different conditions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data analysis apparatus comprising processing circuitry configured to:
acquire a plurality of pieces of first data satisfying a first condition;
generate a plurality of first feature vectors by unsupervised learning of the plurality of pieces of first data;
generate a first clustering result by clustering the plurality of first feature vectors;
acquire a plurality of pieces of second data satisfying a second condition different from the first condition;
generate a plurality of second feature vectors by unsupervised learning of at least some of the plurality of pieces of first data and the plurality of pieces of second data;
generate a second clustering result by clustering the second feature vectors; and
generate a comparison result regarding the plurality of pieces of first data and the plurality of pieces of second data by comparing the first clustering result with the second clustering result.

2. The data analysis apparatus according to claim 1, wherein the first clustering result includes data in which information about each of the first feature vectors is associated with a first cluster number for distinguishing each cluster, and the second clustering result includes data in which information about each of the second feature vectors is associated with a second cluster number for distinguishing each cluster.

3. The data analysis apparatus according to claim 2, wherein the first clustering result includes a first cluster label corresponding to the first cluster number.

4. The data analysis apparatus according to claim 1, wherein the processing circuitry is further configured to perform unsupervised learning using a model that extracts a feature amount such that a distance between similar images is short and a distance between dissimilar images is long.

5. The data analysis apparatus according to claim 1, wherein the comparison result is a graph indicating a ratio between the first data and the second data that are included in a cluster in the second clustering result.

6. The data analysis apparatus according to claim 1, wherein the comparison result is a correlation diagram in which the first feature vectors and the second feature vectors are represented by a plurality of different components.

7. The data analysis apparatus according to claim 1, wherein the processing circuitry is further configured to perform clustering such that the number of clusters included in the second clustering result is larger than the number of clusters included in the first clustering result.

8. The data analysis apparatus according to claim 1, wherein types of the first condition and the second condition are any of different apparatuses, a date and time, before and after maintenance, and before and after a change in a manufacturing process.

9. The data analysis apparatus according to claim 1, wherein the first data and the second data are images.

10. A data analysis method comprising:
acquiring a plurality of pieces of first data satisfying a first condition;
generating a plurality of first feature vectors by unsupervised learning of the plurality of pieces of first data;
generating a first clustering result by clustering the plurality of first feature vectors;
acquiring a plurality of pieces of second data satisfying a second condition different from the first condition;
generating a plurality of second feature vectors by unsupervised learning of at least some of the plurality of pieces of first data and the plurality of pieces of second data;
generating a second clustering result by clustering the second feature vectors; and
generating a comparison result regarding the plurality of pieces of first data and the plurality of pieces of second data by comparing the first clustering result with the second clustering result.

11. A non-transitory computer-readable storage medium storing a program for causing a computer to execute processing comprising:
acquiring a plurality of pieces of first data satisfying a first condition;
generating a plurality of first feature vectors by unsupervised learning of the plurality of pieces of first data;
generating a first clustering result by clustering the plurality of first feature vectors;
acquiring a plurality of pieces of second data satisfying a second condition different from the first condition;
generating a plurality of second feature vectors by unsupervised learning of at least some of the plurality of pieces of first data and the plurality of pieces of second data;
generating a second clustering result by clustering the second feature vectors; and
generating a comparison result regarding the plurality of pieces of first data and the plurality of pieces of second data by comparing the first clustering result with the second clustering result.
